(19) United States
(12) Patent Application Publication
(10) Pub. No.: US 2011/0267323 A1
(43) Pub. Date: Nov. 3, 2011

(54) ELECTRO-OPTICAL APPARATUS AND ELECTRONICS DEVICE

(75) Inventor: Shinsuke FUJIKAWA, Chino-shi (JP)

(73) Assignee: SEIKO EPSON CORPORATION, Tokyo (JP)

(21) Appl. No.: 13/094,738

(22) Filed: Apr. 26, 2011

(30) Foreign Application Priority Data
Apr. 28, 2010 (JP) 2010-103107

(51) Int. Cl. G06F 3/038

(52) U.S. Cl. 345/206

(57) ABSTRACT

An electro-optical apparatus is configured to form n (n is an integer greater than or equal to 2) lines of scanning lines into a group, and include a scanning line driving circuit configured to select the scanning lines on a group-by-group basis, a data line driving circuit configured to supply pixels corresponding to selected n lines of scanning lines with data signals via n lines of data lines, and a capacitor line driving circuit configured to cause voltages supplied to n lines of capacitor lines, which are provided so as to correspond to respective selected n lines of scanning lines to be first voltages when the scanning lines have been selected, and after an appropriate period of time, shift the first voltages to second voltages.

### BACKGROUND

1. Technical Field

The present invention relates to a technology which enables suppression of voltage amplitudes of respective data lines in an electro-optical apparatus using liquid crystal or the like.

2. Related Art

In electro-optical apparatuses each using liquid crystal or the like, pixels are configured by providing pixel capacitances (liquid-crystal capacitances) so as to correspond to respective intersections of scanning lines and data lines. In JP-A-2002-196358, a technology, which is called a capacitor line driving method, for suppressing voltage amplitudes of respective data lines by providing auxiliary capacitors in parallel with pixel capacitances, and further, driving each of capacitor lines, which connect auxiliary capacitors in common on a line-by-line basis, with a predetermined voltage corresponding to one of two voltage levels in synchronization with selection of a scanning line corresponding to the capacitor line, has been described. According to the technology described in JP-A-2002-196358, it is possible to suppress power consumption for driving data lines.

When performing the capacitor line driving method, which has been described in JP-A-2002-196358, at a timing when writing of data into a certain pixel electrode has been completed, it is required that the voltage of a capacitor line corresponding to the certain pixel electrode has reached a predetermined voltage corresponding to one of two voltage levels. However, with respect to a capacitor line, owing to resistance components and capacitive components, a decay time constant is large, and, for example, owing to capacitive coupling, it takes a certain amount of time from a timing when variation of a voltage of a capacitor line is started until a timing when the voltage of the capacitor line has been relaxed to the predetermined voltage. For example, when performing writing of data into a pixel electrode by using a so-called subfield driving method, in which one field consists of a plurality of subfields, a period of time for writing data is so short that, sometimes, before a voltage of a capacitor line corresponding to the pixel electrode has been relaxed to the predetermined voltage, selecting of a scanning line corresponding to the capacitor line has been completed. In this case, as a result, a voltage of the pixel electrode after writing of data has been completed becomes an unintended voltage, so that the unintended voltage is likely to cause defects of display, and thus, is not preferable in the capacitor line driving.

### SUMMARY

One of advantages of the invention is to, in a driving circuit for driving an electro-optical apparatus including capacitor lines, provide a technology for causing a voltage of a capacitor line at a timing when writing of data into a pixel electrode has been completed to become a predetermined voltage.

An electro-optical apparatus according to an aspect of the invention includes a plurality of scanning lines; a plurality of data lines; capacitor lines provided so as to correspond to the respective scanning lines; a pixel including a pixel switching element configured to be provided so as to correspond to an intersection of each line of the scanning lines and each line of the data lines included in each of groups, which are formed for every n (n is an integer greater than or equal to 2) lines of the data lines, have a node that is electrically connected to the each line of the data lines, and further, be in a conductive condition between the node and another node when the each line of the scanning lines is selected, and an auxiliary capacitor configured to have a node that is electrically connected to a pixel capacitance, and the other node that is electrically connected to the capacitor line; a scanning line driving circuit configured to, for each group of the scanning lines, which is formed of n lines of the scanning lines, select the scanning lines; a data line driving circuit configured to supply pixels corresponding to selected n lines of the scanning lines with data signals having voltages in accordance with gray scales for the pixels via the n lines of the data lines forming a group; and a capacitor line driving circuit configured to cause voltages supplied to n lines of the capacitor lines, which are provided so as to correspond to respective selected n lines of the scanning lines, to be first voltages when the n lines of the scanning lines have been selected, and after an appropriate period of time, shift the first voltages to second voltages. An electro-optical apparatus according to the aspect of the invention, which includes capacitor lines, enables a voltage of a certain capacitor line to become a predetermined voltage when writing of data into a pixel electrode corresponding to the certain capacitor line has been completed. Further, the electro-optical apparatus according to the aspect of the invention makes it unnecessary to enhance capability of switches included in the capacitor line driving circuit, and is suitable for reduction of circuit areas of the switches. Further, the electro-optical apparatus according to the aspect of the invention enables decrease of the number of switching of the scanning lines, which is performed every time the scanning lines are selected by the scanning line driving circuit, compared with that in the configuration in which the scanning lines are selected on a line-by-line basis, and thus, the decrease of the number of switching of the scanning lines contributes to downsizing of circuits for switching.

In the electro-optical apparatus according to the aspect of the invention, the scanning line driving circuit may select the scanning lines so that, for n lines of the scanning lines forming a group, between one line of the n lines of the scanning lines and a different line of the n lines of the scanning lines, which is adjacent to the one line of the n lines of the scanning line, a predetermined number of the scanning lines included in each of different groups of the scanning lines can be interposed. According to the aspect of the invention, it is expected to average defects of display due to occurrence of the failure of alignment directions of liquid crystal molecules, i.e., so-called disclination, and cause the defects of display to be unnoticeable.

In the electro-optical apparatus according to the aspect of the invention, n mutually adjacent lines of the scanning lines may form a group. According to the aspect of the invention, it is expected to reduce portions where the failure of alignment directions of liquid crystal molecules, i.e., so-called disclination, occurs.

In the electro-optical apparatus according to the aspect of the invention, preferably, n lines of the capacitor lines, which are provided so as to correspond to the respective n lines of the scanning lines forming a group, have respective one side edges thereof, which are electrically connected to the capacitor line driving circuit, and the respective other side edges thereof, which are electrically connected to one another. According to the aspect of the invention, it is possible to suppress occurrence of so-called lateral crosstalk.

In the electro-optical apparatus according to the aspect of the invention, the data line driving circuit includes n data line driving circuits, and each of the data line driving circuits sequentially supplies data signals to respective pixels that are provided so as to correspond to one of the scanning lines, and to pixels that are provided so as to correspond to the n lines of the scanning lines forming a group, the data line driving circuits, which are different for the respective n lines of the scanning lines, may supply data signals. According to the aspect of the invention, it is possible to apply driving circuits of data line driving circuits having been already manufactured to the invention without any devices for structures thereof.

In addition, the invention can be practiced as not only an electro-optical apparatus but also an electronics device including the above-described electro-optical apparatus according to the aspect of the invention.

### BRIEF DESCRIPTION OF THE DRAWINGS

The invention will be described with reference to the accompanying drawings, wherein like numbers reference like elements.

FIG. 1 is a block diagram illustrating the whole configuration of an electro-optical apparatus according to a first embodiment of the invention.

FIG. 2 is a diagram illustrating an equivalent circuit of a pixel and a configuration surrounding the pixel, according to a first embodiment of the invention.

FIG. 3 is a timing chart illustrating time-series changes of individual signals outputted by a display control circuit according to a first embodiment of the invention.

FIG. 4 is a diagram illustrating a configuration of a data line driving circuit according to a first embodiment of the invention.

FIG. 5 is a diagram illustrating a configuration of a capacitor line driving circuit according to a first embodiment of the invention.

FIG. 6 is a diagram illustrating a configuration resulting from reconfiguring a configuration shown in FIG. 2 by using a different equivalent circuit.

FIG. 7 is a diagram illustrating a state of changes of a pixel electrode, according to a first embodiment of the invention.

FIGS. 8A and 8B are timing charts each illustrating a state of time-series changes of a voltage of a pixel, according to a first embodiment of the invention.

FIG. 9 is a block diagram illustrating the whole configuration of an electro-optical apparatus according to a second embodiment of the invention.

FIGS. 10A is a diagram illustrating polarities of pixel electrodes corresponding to respective pixels, according to a first embodiment of the invention.

FIGS. 10B is diagram illustrating polarities of pixel electrodes corresponding to respective pixels, according to a second embodiment of the invention.

FIG. 11 is a block diagram illustrating the whole configuration of an electro-optical apparatus according to a third embodiment of the invention.

FIG. 12 is a block diagram illustrating the whole configuration of an electro-optical apparatus according to a fourth embodiment of the invention.

FIG. 13 is a diagram illustrating a configuration of a data line driving circuit according to a fourth embodiment of the invention.

FIG. 14 is a diagram illustrating a mobile-phone using an electro-optical apparatus according to any one of embodiments of the invention.

### DESCRIPTION OF EXEMPLARY EMBODIMENTS

Hereinafter, embodiments according to the invention will be described with reference to drawings.

### First Embodiment

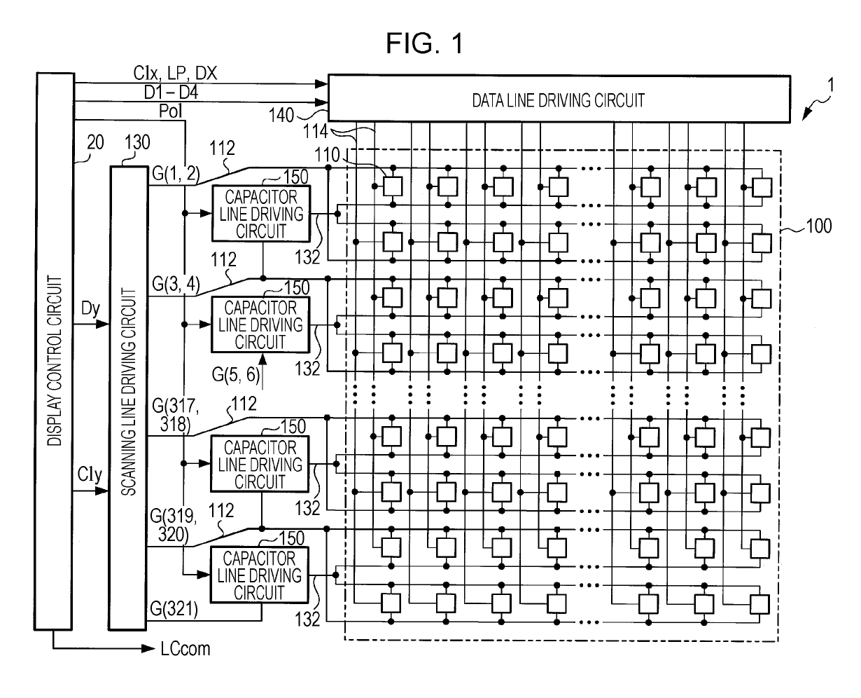

FIG. 1 is a block diagram illustrating the whole configuration of an electro-optical apparatus according to a first embodiment of the invention.

As shown in FIG. 1, an electro-optical apparatus 1 is configured by a panel of peripheral circuit built-in type, including a display area 100 and driving circuits allocated in peripheral areas thereof, which are a scanning line driving circuit 130, a data line driving circuit 140 and a plurality of (in this case, 160 units of) capacitor line driving circuits 150. A display control circuit 20 is connected to the panel of peripheral circuit built-in type via, for example, a flexible printed circuit (FPC) substrate.

The display area 100 is an area in which a plurality of pixels 110 are arrayed. In the display area 100, scanning lines 112, which includes 320 lines, i.e., a 1st line, a 2nd line, a 3rd line, . . . , and a 320th line, are provided so as to extend in a uniaxial direction (in a line direction, in FIG. 1). Further, in the display area 100, data lines 114, which includes 480 lines, i.e., a 1st row, a 2nd row, a 3rd row, . . . , and a 480th row, are provided so as to extend in a uniaxial direction orthogonal to the scanning lines 112 (in a vertical direction, in FIG. 1). Each of the data lines 114 and each of the scanning lines 112 are provided so as to mutually maintain electrical insulation. Further, pixels 110 corresponding to respective intersections of the scanning lines 112 of 320 lines and the data lines 114 of 480 rows are provided so that each of the pixels 110 is allocated so as to correspond to an intersection of one of the scanning lines 112 and one of the data lines 114 forming a group for every n rows of data lines (in this case, n=2). Therefore, in the display area 100, the pixels 110 are arrayed in a matrix of vertical direction: 320 lined×horizontal direction: 240 rows.

Further, capacitor lines (storage lines) 132 corresponding to the respective scanning lines 112 of 1st to 320th lines are provided so as to extend in a line direction.

In addition, in addition to the 1st to 320th lines, a 321st line of the scanning lines 112 is provided, and this scanning line 112 does not correspond to any one of the pixels 110, but functions as a dummy scanning line. This dummy scanning line assists capacitor line driving performed by the capacitor line driving circuit 150 to which 319th and 320th lines of the capacitor lines 132 are connected. The function of the dummy scanning line will be described below.

Further, in the display area 100, n (=2) mutually adjacent lines are formed as a group, and the scanning lines 112 included in each group are simultaneously selected by the scanning line driving circuit 130. Specifically, an i-th line (one of odd numbered lines of 1st to 320th lines) of the scanning lines 112 and an (i+1)th line (one of even numbered lines of 1st to 320th lines) of the scanning lines 112 are connected to each other between the display area 100 and the scanning line driving circuit 130. A scanning signal, which is supplied when such i-th and (i+1)th lines of the scanning lines 112 are simultaneously selected, will be hereinafter denoted by a scanning signal “G (i, i+1)”. In addition, a scanning signal, which is supplied to the 321st line of the scanning lines 112, will be denoted by “G (321)”. Further, for the capacitor lines 132 as well, which are provided so as to correspond to the respective scanning lines 112, n (n=2) mutually adjacent lines of the capacitor lines 132 are driven by one of the capacitor line driving circuit 150 which is common thereto. Specifically, an i-th line (one of odd numbered lines of 1st to 320th lines) of the capacitor lines 132 and an (i+1)th line (one of even numbered lines of 1st to 320th lines) of the capacitor lines 132 are connected to each other between the display area 100 and the capacitor line driving circuit 150. A capacitor signal, which is supplied to the i-th and (i+1)th lines of the capacitor lines 132, will be hereinafter denoted by “Sc (i, i+1)”.

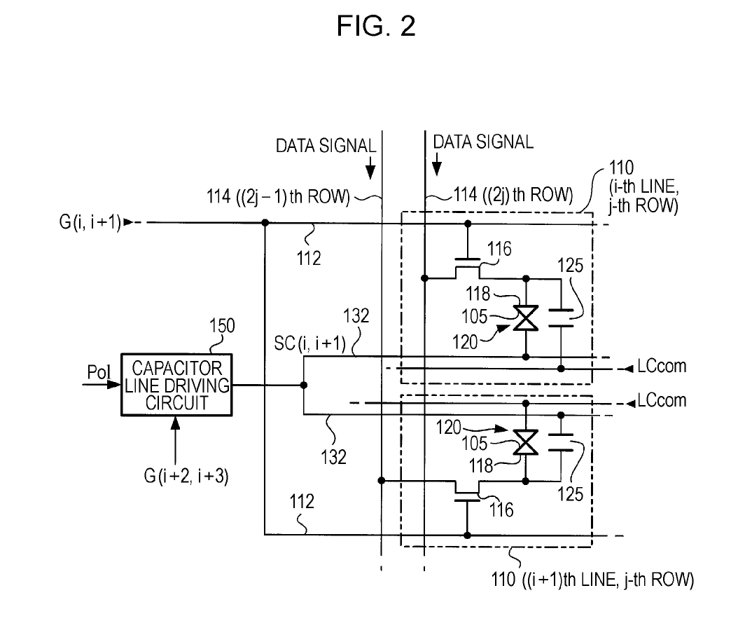

FIG. 2 is a diagram illustrating equivalent circuits of the pixels 110 and a configuration surrounding the pixels. Specifically, FIG. 2 is a diagram illustrating the pixels 110, which correspond to respective intersections of a j-th (j=1 to 240) row and an i-th line (an odd numbered line); and the j-th row and an (i+1)th line (an even numbered line), one of the scanning lines 112, one of the capacitor lines 132, which are connected to the pixels 110, and the capacitor line driving circuit 150. As shown in FIG. 2, here, the pixel 110 corresponding to the i-th line and the pixel 110 corresponding to the (i+1)th line are located so as be symmetric above and below an imaginary mid-lateral line, but such a location symmetric above and below an imaginary mid-lateral line is not essential.

As shown in FIG. 2, the pixel 110 includes a pixel capacitance (here, which is a liquid crystal element) 120 having liquid crystal 105 interposed between a pixel electrode 118 and a common electrode 108. Here, it is assumed that the liquid crystal 105 employs the VA method, and is in a normally black mode in which the pixel capacitance 120 is in a black condition when no voltage is supplied thereto. Further, in this equivalent circuit, an auxiliary capacitor (a storage capacitor) 125 is provided in parallel with the pixel capacitance 120. The auxiliary capacitor 125 has two nodes, one being electrically connected to the pixel electrode 118, the other one being connected to the capacitor line 132 in common.

Here, when the scanning line 112 becomes an H level, a TFT 116, having a gate electrode electrically connected to the scanning line 112, is turned on, so that the pixel electrode 118 is connected to the data line 114. Therefore, while the scanning line 112 is at an H level, once a data signal having a voltage level in accordance with a gray scale is supplied to the data line 114, the data signal is supplied to the pixel electrode 118 via the TFT 116 having been turned on. Further, when the scanning line 112 becomes an L level, the TFT 116 is turned off, but a voltage having been supplied to the pixel electrode 118 is maintained by a capacitance component of the pixel capacitance 120 and the auxiliary capacitor 125.

In the pixel capacitance 120, an alignment condition of molecules of the liquid crystal 105 varies in accordance with electric fields caused by the pixel electrode 118 and the common electrode 108. For this reason, in the case of a refection type, the pixel capacitance 120 has a reflectance in accordance with an applied/hold voltage. In the display area 100, the reflectance varies for each of the pixel capacitances 120, and therefore, the pixel capacitance 120 corresponds to the pixel 110.

Further, the pixel 110 corresponding to an i-th line, i.e., an odd numbered line, is connected to the data line 114 corresponding to a (2j)th (j=1 to 240) row, i.e., an even numbered row, and the pixel 110 corresponding to an (i+1)th line, i.e., an even numbered line, is connected to the data line 114 corresponding to a (2j-1)th row, i.e., an odd numbered row. That is, the pixel 110 corresponding to an intersection of the i-th line and the j-th row and the pixel 110 corresponding to an intersection of the (i+1)th line and the j-th row are connected to the respective data lines 114 which are different from each other. A reason for employing such a configuration is to make it possible to, at a timing when the respective pixels 110 corresponding to the i-th line and the (i+1)th line are simultaneously selected by the scanning line driving circuit 130, supply mutually different data signals to the respective pixels 110. This supply operations will be hereinafter described.

Further, the pixel capacitance 120 associated with the pixel 110 corresponding to the i-th line has two nodes, one being electrically connected to the TFT 116, the other one being electrically connected to the capacitor line 132 corresponding to the i-th line. In the same manner, the pixel capacitance 120 associated with the pixel 110 corresponding to the (i+1)th line has two nodes, one being electrically connected to the TFT 116, the other one being electrically connected to the capacitor line 132 corresponding to the (i+1)th line. Moreover, these capacitor lines 132 corresponding to the i-th line and the (i+1) line are electrically connected to the capacitor line driving circuit 150, which is common thereto.

The display area 100, which includes the pixels 110 arrayed therein, each being configured in such a manner as described above, is configured to include an element substrate on which the pixel electrodes 118 are formed, and an opposite substrate on which the common electrode 108 is formed, a pair of the substrates being bonded to each other so as to cause the surfaces thereof on which electrodes are formed to be opposite each other, and cause a constant distance therebetween to be kept, and further, is configured to include the liquid crystal 105 sealed within the distance. Consequently, owing to such a configuration as described above, the pixel capacitance 120 is configured to include the liquid crystal 105, which is a kind of dielectric materials, interposed by the pixel electrode 118 and the common electrode 108, and maintain a voltage difference between the pixel electrode 118 and the common electrode 118.

Let us return to FIG. 1 and describe it.

The display control circuit 20 performs controlling of individual units of the electro-optical apparatus 1 by outputting various control signals thereto.

Firstly, the display control circuit 20 outputs a start pulse Dy and a clock signal Cly to the scanning line driving circuit 130. Secondly, the display control circuit 20 outputs data bits D1 to D4, a clock signal Clx, a transfer start pulse DX and a latch pulse LP to the data line driving circuit 140. Thirdly, the display control circuit 20 outputs a polarity specification signal Pol to the capacitor line driving circuit 150. Moreover, the display control circuit 20 supplies a common voltage LCcom to the common electrode 108.

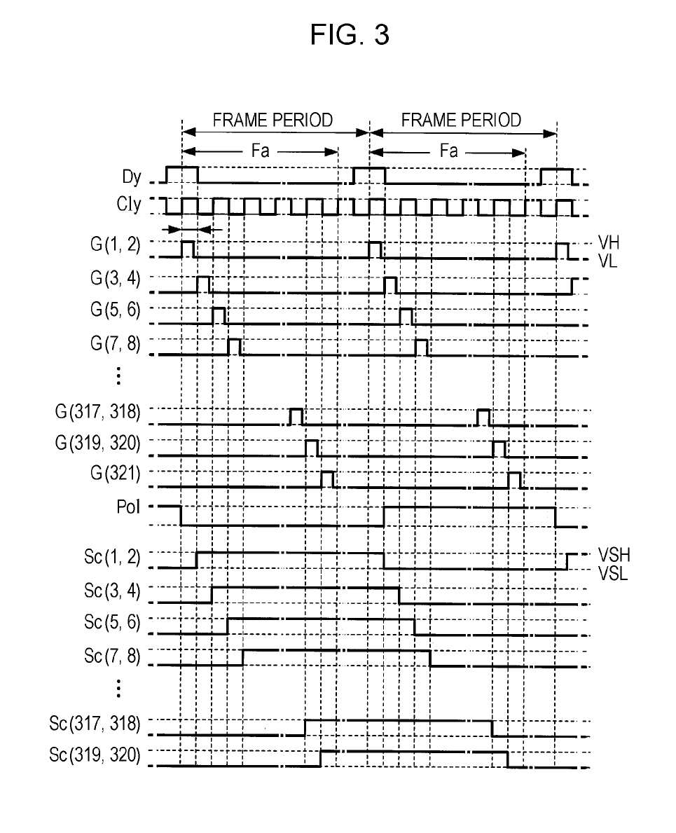

FIG. 3 is a timing chart illustrating time-series changes of respective signals outputted by the display control circuit 20. Hereinafter, configurations and operations of respective units of the electro-optical apparatus 1 will be described with reference to FIG. 3.

Firstly, the scanning line driving circuit 130 will be hereinafter described.

In accordance with the start pulse Dy and the clock signal Cly, the scanning line driving circuit 130 sequentially selects the scanning lines 112, two lines of which form a group, on a group-by-group basis, from above to below in FIG. 1. Specifically, the scanning line driving circuit 130 selects the scanning lines 112 exclusively on a group-by-group basis in a direction along which the value of “i” is incremented. Further, the scanning line driving circuit 130 supplies a scan signal G(i, i+1) to i-th and (i+1)th lines of the scanning lines 112 having been selected. The scanning line driving circuit 130 causes the scan signal supplied to the selected scanning lines 112 to be a selection voltage VH corresponding to an H level, and causes each of the scan signals supplied to the respective scanning lines 112 other than the selected scanning lines 112 to be a non-selection voltage VL corresponding to an L level.

In further details, as shown in FIG. 3, the scanning line driving circuit 130 sequentially shifts the start pulse Dy in accordance with the click signal Cly having a duty ratio of 50%, and makes the pulse width of each of the resultant pulses be narrower than the half cycle of the clock signal Cly to output individual resultant pulses as scan signals G(1, 2), G(3, 4), G(5, 6), G(7, 8), G(9, 10), G(11, 12), . . . , G(317, 318), G(319, 320) and G(321).

In this embodiment, a frame period means a period of time necessary for driving the display area 100 to cause the display area 100 to display one frame of image. If a vertical scanning frequency is 60 Hz, the frame period is the inverse number thereof, i.e., approximately 16.7 millisecond. As shown in FIG. 3, such a frame period includes a vertical effective scanning period Fa, which is a period of time from a timing when the scan signal G(1, 2) becomes an H level until a timing when the scan signal G(321) becomes an L level, and in addition thereto, includes a vertical flyback period.

In addition, a period of time, which is equal to half the cycle of the clock signal Cly, i.e., a period of time while a logical level of the clock signal Cly is kept at a constant level, is called a horizontal scanning period (H). During this horizontal scanning period (H), if a fore portion thereof, that is, a period of time while the scan signal is kept at an H level, is called a horizontal effective scanning period, the remaining period of time is called a horizontal flyback period.

Secondly, contents associated with the data line driving circuit 140 will be hereinafter described.

In order to, for individual subfields, specify on/off drives in accordance with gray-scale levels specified for the respective pixels 110, the display control circuit 20 converts display data specifying a gray-scale level for each pixel, the display data being supplied from an upper apparatus, which is omitted from illustration, into data bits D1 to D4. The display control apparatus 20 stores therein, for example, look-up tables (LUTs) each representing correspondence relations between gray-scale levels and data bits indicating on/off drives for individual subfields, and performs conversions into the data bits in accordance with the correspondence relations. The data bits D1 to D4 supplied to the data line driving circuit 140 from the display control circuit 20 are digital data for controlling gray scales (densities) for the respective pixels 110. That is, in the electro-optical apparatus 1, the pixel 110 performs displaying of gray scales in accordance with the data bits D1 to D4. In this case, the display control circuit 20 supplies the data bits D1 to D4 representing either of a data signal being kept at an H level corresponding to a predetermined high-level side voltage or a data signal being kept at an L level corresponding to a predetermined low-level side voltage so that writing of data is performed with a writing polarity specified by the polarity specification signal Pol the same as that supplied to the capacitor line driving circuit 150.

Here, the polarity specification signal Pol is a signal for specifying a writing polarity during the horizontal effective period so that the writing polarity becomes a negative polarity if a logical level of the polarity specification signal Pol is an H level, and the writing polarity becomes a positive polarity if a logical level of the polarity specification signal Pol is an L level. In this embodiment, the display control apparatus 20 performs switching of logical levels of the polarity specification signal Pol for each frame period so that the writing polarities can be switched in accordance with a so-called image inversion method. Regarding the writing polarity, when causing the pixel capacitance 120 to maintain a voltage corresponding to a gray-scale level, the writing polarity is called “a positive polarity” in the case where a voltage of the pixel electrode 118 is caused to be at a higher side than that of the common voltage LCcom, and the writing polarity is called “a negative polarity” in the case where a voltage of the pixel electrode 118 is caused to be at a lower side than that of the common voltage LCcom. Regarding voltages, except a case where any particular explanations are made, a voltage of a ground of a power sully, which is omitted from illustration, is a reference, i.e., a voltage zero point, of the voltages.

More specifically, in the case where a writing polarity is a positive polarity, the display control circuit 20 outputs H-level data bits representing a voltage higher than the predetermined common voltage LCcom by, for example, 2.5V when performing on-driving of the pixel 110, and outputs L-level data bits representing a voltage level lower than the predetermined common voltage LCcom by, for example, 2.5V when performing off-driving of the pixel 110. Meanwhile, in the case where a writing polarity is a negative polarity, the display control circuit 20 outputs L-level data bits representing a voltage lower than the predetermined common voltage LCcom by, for example, 2.5V when performing on-driving of the pixel 110, and outputs H-level data bits representing a voltage level higher than the predetermined common voltage LCcom by, for example, 2.5V when performing off-driving of the pixel 110.

In addition, the above-described voltages of the data signal is just an example, and may be voltages other than the above-described voltages.

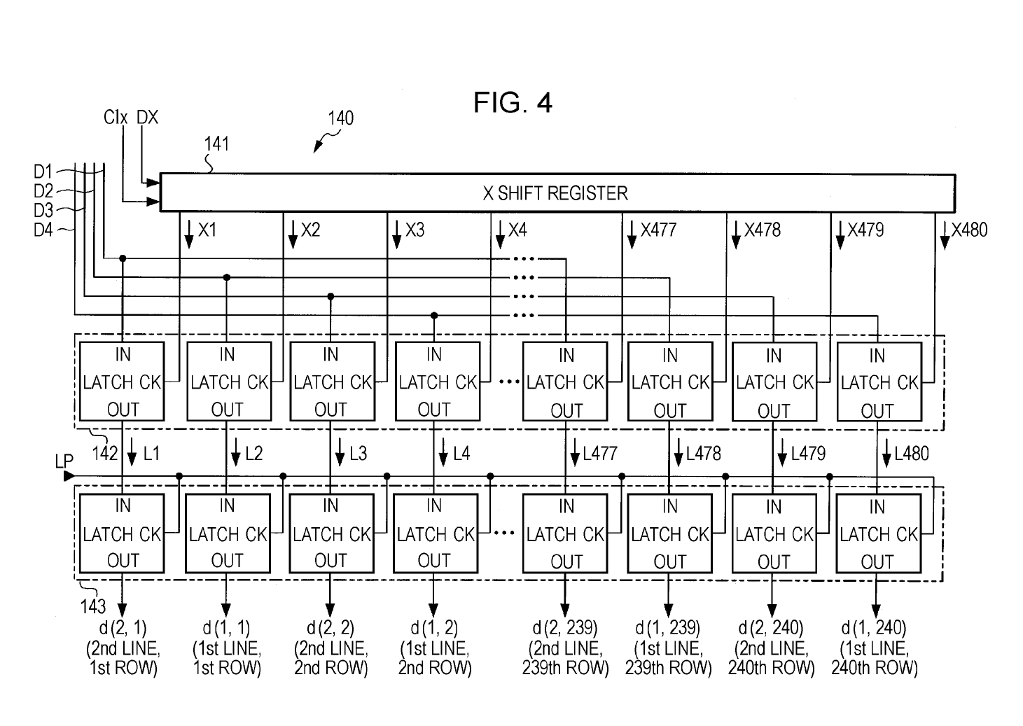

FIG. 4 is a diagram illustrating a configuration of the data line driving circuit 140. Here, operations performed by the data line driving circuit 140 will be described by providing a case as an example, in which 1st and 2nd lines of the scanning lines are selected as an example.

The data line driving circuit 140 is configured to, in a certain horizontal scanning period, sequentially latches the data bits D1 to D4 so as to obtain 480 latched outputs, the number of which corresponds to that of the data lines 114, and during a subsequent horizontal scanning period, on the basis of the 480 data bits D1 to D4 having been latched, simultaneously supplies data signals d(2, 1), d(1, 1), d(2, 2), d(1, 2), . . . , d(2, 239), d(1, 239), d(2, 240), d(1, 240) to the corresponding data lines 114. Such a symbol (x, y) denotes a data signal that is supplied to a pixel corresponding to an x-th line and a y-th row. As described above, the data line driving circuit 140 is configured to sequentially supply data signals to the respective pixels 110, which are provided so as to correspond to n (=2) lines of the scanning lines 112 forming a group.

In addition, the data bit D1 is data determining data signals supplied to the pixels 110 corresponding to even numbered lines and odd numbered rows. The data bit D2 is data determining data signals supplied to the pixels 110 corresponding to odd numbered lines and odd numbered rows. The data bit D3 is data determining data signals supplied to the pixels 110 corresponding to even numbered lines and even numbered rows. The data bit D4 is data determining data signals supplied to the pixels 110 corresponding to odd numbered lines and even numbered rows.

Specifically, the data line driving circuit 140 includes an X shift register 141, a first group of latch circuits 142 and a second group of latch circuits 143.

The X shift register 141 sequentially shifts the transfer start pulse DX, which is supplied at the beginning of each horizontal scanning period, at respective timings of rising and falling edges of the clock signal Clx, and sequentially and exclusively supplies output signals as latch signals X1, X2, X3, . . . , and X480. The first group of latch circuits 142 sequentially latches the data bits D1 to D4 at respective timings of rising edges of the latch signals X1, X2, X3, . . . , and X480, and supplies output signals as latch signals L1, L2, L3, . . . , and L480. The second group of latch circuits 143 simultaneously latches the individual latch signals resulting from latching performed by the first group of latch circuits 142 at a timing of the rising edge of the latch pulse LP, and then, supplies the latched signals to the corresponding data lines 114 as data signals.

Contents associated with the capacitor line driving circuit 150 will be hereinafter described with reference to FIG. 3.

As shown in FIG. 3, a capacitor signal Sc (i, i30 1), which is outputted to i-th and (i+1)th lines of the capacitor lines 132 by the capacitor line driving circuit 150, is a signal that becomes a voltage VSL (a first voltage), which is a lower-side level of two voltage levels when a signal resulting from sampling the polarity specification signal Pol is at an L level, and becomes a voltage VSH (a first voltage), which is a higher-side level of two voltage levels when a signal resulting from sampling the polarity specification signal Pol is at an H level.

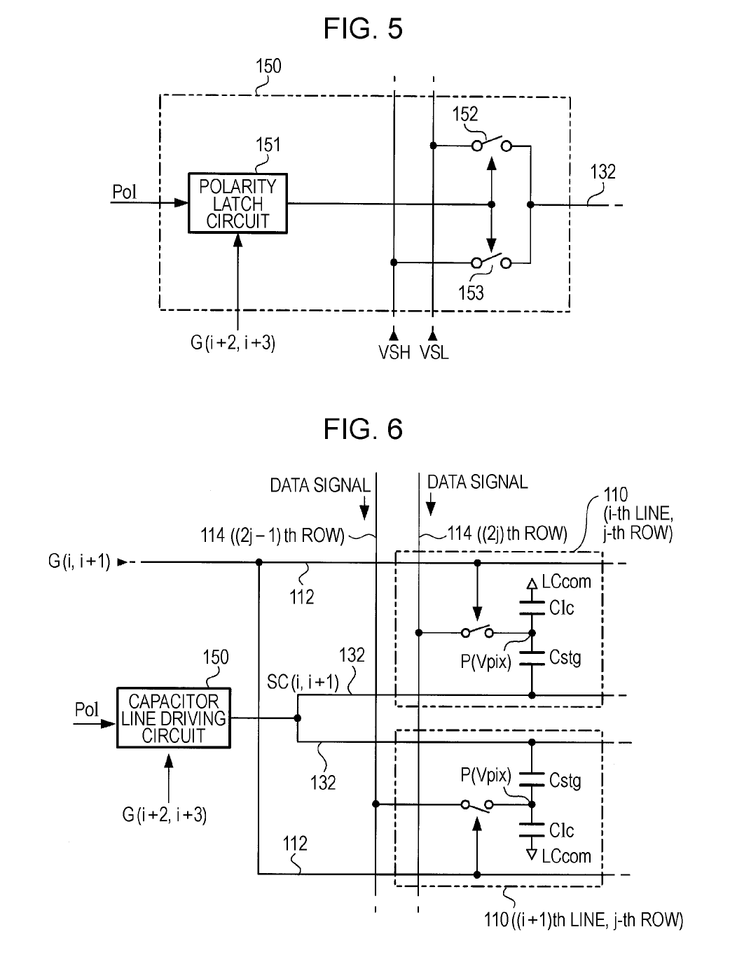

FIG. 5 is a diagram illustrating a configuration of the capacitor line driving circuit 150.

The capacitor line driving circuit 150 includes a polarity latching circuit 151 and switches 152 and 153. Hereinafter, the capacitor line driving circuit 150 connected to i-th and (i+1)th lines of the capacitor lines 132 will be described.

The polarity latching circuit 151 a circuit for causing the capacitor line 132 to be either of the voltage VSH, i.e., a higher-side level of two voltage levels, or the voltage VSL, i.e., a lower-side level of two voltage levels, in accordance with the polarity specification signal Pol having been latched, and selection or non-selection of (i+2)th and (i+3)th lines of the scanning lines 112. Specifically, when a scan signal G(i+2, i+3) corresponding to (i+2)th and (i+3)th lines moves from an L level to an H level, at each timing of rising edges of the scan signal G(i+2, i+3), the polarity latching circuit 151 performs latching of the polarity specification signal Pol, and outputs a control signal for controlling on/off of the switches 152 and 153. When a logical level of the polarity specification signal Pol is an L level (that is, when positive polarity writing is specified), at a timing at which (i+2)th and (i+3)th lines of the scanning lines 112 are selected and the voltage levels thereof are switched from an L level to an H level, the polarity latching circuit 151 causes the switch 153 to be in a conductive condition and causes the switch 152 to be in a non-conductive condition so that the voltage VSH (a second voltage), which is a higher-side level of two voltage levels, can be supplied to the capacitor line 132. The polarity latching circuit 151 maintains this conductive condition until a timing at which, next, the (i+2)th and (i+3)th lines of the scanning line 112 are selected and the voltage levels thereof are switched from an L level to an H level. Meanwhile, when a logical level of the polarity specification signal Pol is an H level (that is, when negative polarity writing is specified), a timing at which (i+2)th and (i+3)th lines of the scanning lines 112 are selected and the voltage levels thereof are switched from an L level to an H level, the polarity latching circuit 151 causes the switch 152 to be in a conductive condition and causes the switch 153 to be in a non-conductive condition so that the voltage VSL (a second voltage), which is a lower-side level of two voltage levels, can be supplied to the capacitor line 132. The polarity latching circuit 151 maintains this conductive condition until a timing at which, next, the (i+2)th and (i+3)th lines of the scanning line 112 are selected and the voltage levels thereof are switched from an L level to an H level.

Hereinbefore, the whole configuration of the electro-optical apparatus 1 has been described.

FIG. 6 is a diagram illustrating a configuration resulting from replacing a configuration shown in FIG. 2 by using a different equivalent circuit.

As shown in FIG. 6, the pixel capacitance 120 can be regarded as a capacitive element having a capacitance value Clc, and the auxiliary capacitor 125 cab be regarded as a capacitive element having a capacitance value Cstg. Further, a voltage of a connection point P of the pixel capacitance 120 and the auxiliary capacitor 125 will be denoted by “Vpix” hereinafter.

Subsequently, operations performed by the electro-optical apparatus 1 will be hereinafter described.

Firstly, once a voltage of the scan signal G(1, 2), which is supplied to 1st and 2nd lines of the scanning lines 112, becomes an H level, the TFTs 116 associated with pixels corresponding to respective intersections of a 1st line and a 1st row; a 1st line and a 2nd row; . . . ; and a 1st line and a 240th row, and a 2nd line and a 1st row; a 2nd line and a 2nd row; . . . ; and a 2nd line and a 240th row are turned on, the respective pixel electrodes 118 corresponding to these pixels are supplied with data signals d(2, 1), d(1, 1), d(2, 2), d (1, 2), . . . , d(2, 239), d(1, 239), d(2, 240), and d(1, 240). Therefore, each of the pixel capacitances 120 associated with the pixels 110 corresponding to respective intersections of a 1st line and a 1st row; a 1st line and a 2nd row; . . . ; and a 1st line and a 240th row, and a 2nd line and a 1st row; a 2nd line and a 2nd row; . . . ; and a 2nd line and a 240th row is supplied with a voltage difference between a voltage of the corresponding data signal and the common voltage LCcom of the common electrode 108. Here, during the horizontal effective scanning period Fa while the scan signal G(1, 2) is at an H level, when the polarity specification signal Pol is at an L level, and positive polarity writing is specified, a voltage of the capacitor signal Sc (1, 2) supplied to the 1st and 2nd lines of the capacitor lines 132 is the voltage VSL, which is a lower-side level of two voltage levels. Therefore, each of the auxiliary capacitors 125 corresponding to respective intersections of a 1st line and a 1st row; a 1st line and a 2nd row; . . . ; and a 1st line and a 240th row, and a 2nd line and a 1st row; a 2nd line and a 2nd row; . . . ; and a second line and a 240th row is supplied with a voltage difference between a voltage of a data signal and the voltage VSL.

Further, when the scan signal G(1, 2) moves to an L level, the TFTs 116 associated with the pixels 110 corresponding to respective intersections of a 1st line and a 1st row; a 1st line and a 2nd row; . . . ; and a 1st line and a 240th row, and a 2nd line and a 1st row; a 2nd line and a 2nd row; . . . ; and a 2nd line and a 240th row are turned off. Further, when the scan signal G(3, 4) moves to an H level, a voltage of the capacitor signal Sc (1, 2) supplied to the 1st and 2nd lines of the capacitor lines 132 is shifted to the voltage VSH, which is a higher-side level of two voltage levels.

Here, supposing that a voltage of a data signal is a voltage Vj, the voltage Vpix of the pixel electrode 118, which is equal to a voltage of a connection point P between the pixel capacitance 120 and the auxiliary capacitor 120, theoretically satisfies a relation represented by the following formula (1). In addition, in the formula (1), for the sake of convenience for explanation, other parasitic capacitance components of a pixel electrode are omitted.

Vpix=Vj+{Cstg/(Cstg+Clc)}·ΔV (1)

That is, a voltage supplied to the pixel capacitance 120 becomes higher than a voltage of a data signal by a value resulting from multiplying a voltage variation of the capacitor line 132 for i-th and (i+1)th lines: ΔV by a capacitance ratio of the pixel capacitance 120 and a capacitance of the auxiliary capacitor 125: {Cstg/(Cstg+Clc)}. In other words, when a voltage of the scan signal (1, 2) of the capacitor line 132 for 1st and 2nd lines becomes higher by ΔV, the voltage Vpix of the pixel electrode 118 becomes higher than the voltage Vj of a data signal supplied during the scan signal G(1, 2) is kept at an H level by a voltage: {Cstg/(Cstg+Clc)}·ΔV (which will be denoted by ΔVpix).

Here, a voltage of a data signal during the horizontal effective scanning period Fa while positive polarity writing is specified is set to a voltage resulting from foreseeing that a voltage of the pixel electrode 118 becomes higher by a voltage ΔVpix. That is, the voltage of a data signal is set so that a voltage of the pixel electrode 118 after having become higher can be higher than the common voltage LCcom of the common electrode 108, and a voltage difference therebetween can be a value appropriate to a gray scale. In such a manner, positive polarity voltages appropriate to respective gray scales are maintained for the pixel capacitance 120.

Subsequently, once a voltage of the scan signal G(3, 4) becomes an H level, the TFTs 116 associated with pixels corresponding to respective intersections of a 3rd line and a 1st row; a 3rd line and a 2nd row; . . . ; and a 3rd line and a 240th row, and a 4th line and a 1st row; a 4th line and a 2nd row; . . . ; and a 4th line and a 240th row are turned on, and the respective pixel electrodes 118 corresponding to these pixels are supplied with data signals d(4, 1), d(3, 1), d(4, 2), d (3, 2), . . . , d(4, 239), d(3, 239), d(4, 240), and d(3, 240). Therefore, each of the pixel capacitances 120 corresponding to the respective intersections of the 3rd line and the 1st row; the 3rd line and the 2nd row; . . . ; and the 3rd line and the 240th row, and the 4th line and the 1st row; the 4th line and the 2nd row; . . . ; and the 4th line and the 240th row is supplied with a voltage difference between a voltage of the corresponding data signal and the common voltage LCcom.

During the horizontal effective scanning period Fa while the polarity specification signal Pol is at an L level, and positive polarity writing is specified, each of scan signals G(1, 2), G(3, 4), G(5, 6), . . . , G(319, 320) sequentially becomes an H level, and therefore, for each of a group of 3rd and 4th lines, a group of 5th and 6th lines, . . . , a group of 317th and 318th lines, and a group of 319th and 320th lines, operations the same as those for the group of 1st and 2nd lines are performed.

Meanwhile, when the polarity specification signal Pol is kept to an H level, and negative polarity writing is specified, during the horizontal effective scanning period Fa while the scan signal G(1, 2) becomes an H level, the capacitor signal Sc (1, 2) supplied to the capacitor lines 132 for the 1st and 2nd lines becomes the voltage VSH, which is a higher-side level of two voltage levels. Further, when the scan signal G(3, 4) moves to an H level, the capacitor signal Sc (1, 2) supplied to the capacitor lines 132 for the 1st and 2nd lines becomes the voltage VSL, which is a lower-side level of two voltage levels. Here, focusing on a J-th row, the voltage Vpix of the pixel electrode 118, which is equal to a voltage of the connection point P, theoretically satisfies a relation represented by the following formula (2). In addition, in the same manner as that for the formula (1), for the sake of convenience for explanation, in the formula (2), other parasitic capacitance components of a pixel electrode are omitted.

Vpix=Vj−{Cstg/(Cstg+Clc)}·ΔV (2)

That is, a voltage supplied to the pixel capacitance 120 becomes lower than a voltage of a data signal by a value resulting from multiplying a voltage variation of the capacitor line 132: ΔV by a capacitance ratio of the pixel capacitance 120 and a capacitance of the auxiliary capacitor 125: {Cstg/(Cstg+Clc)}.

Here, a voltage of a data signal during the horizontal effective scanning period Fa while negative polarity writing is specified is set to a voltage Vj resulting from foreseeing that a voltage of the pixel electrode 118 becomes lower by a voltage ΔVpix. That is, the voltage of a data signal is set so that a voltage of the pixel electrode 118 after having become lower can be lower than the common voltage LCcom of the common electrode 108, and a voltage difference therebetween can be a value appropriate to a gray scale.

Further, during the horizontal effective scanning period Fa while the polarity specification signal Pol is kept at an H level, and negative polarity writing is specified, each of the scan signals G(1, 2), G(3, 4), G(5, 6), . . . , G(319, 320) sequentially becomes an H level, and therefore, for each of a group of 3rd and 4th lines, a group of 5th and 6th lines, . . . , a group of 317th and 318th lines, and a group of 319th and 320th lines, operations the same as those for the group of 1st and 2nd lines are performed.

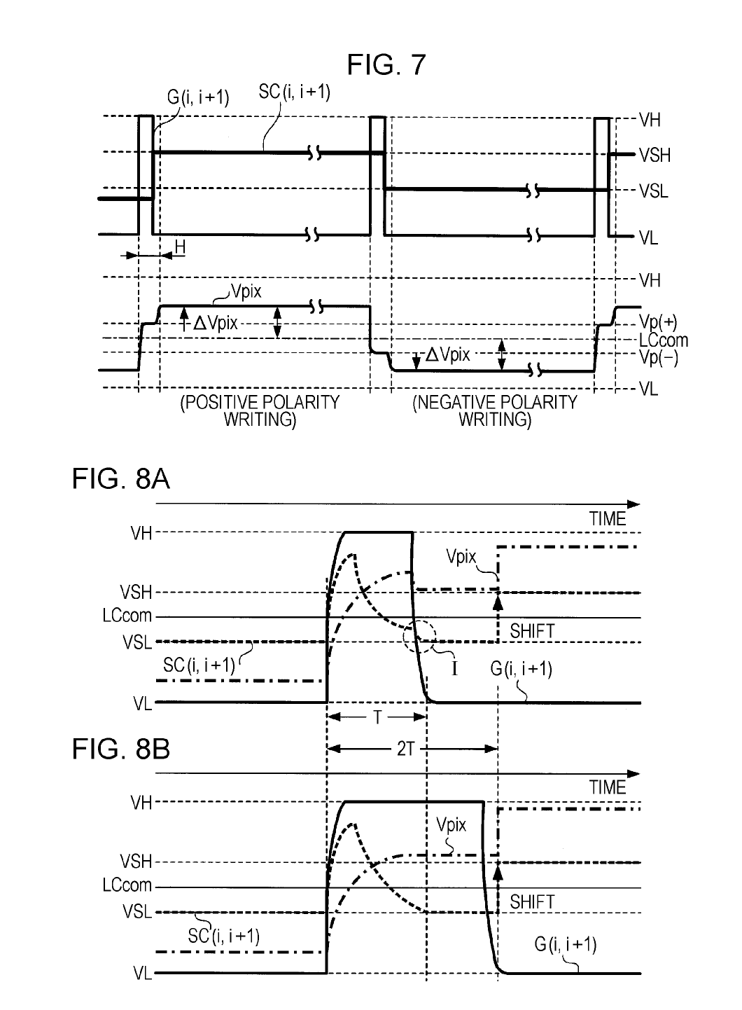

FIG. 7 is a diagram illustrating how the voltage Vpix of each of the pixel electrodes 118 corresponding to respective intersections of an i-th line and a j-th row, and an (i+1)th line and a j-th row varies relative to a scan signal G(i, i+1) for the i-th and (i+1)th lines and a capacitor signal Sc(i, i+1) for the i-th and (i+1)th lines.

As shown in FIG. 7, when the scan signal(i, i+1) becomes an H level, if positive polarity writing is specified, the voltage of the pixel electrode 118 is equal to a voltage Vp(+) of the data signal. Subsequently, the capacitor signal Sc(i, i+1) supplied to the capacitor line 132 is switched from the voltage VSL to the voltage VSH, so that the voltage Vipx becomes higher by the voltage ΔVpix. In contrast, if negative polarity writing is specified, the voltage of the pixel electrode 118 is equal to a voltage Vp(−) of the data signal, and subsequent thereto, the capacitor signal Sc(i, i+1) supplied to the capacitor line 132 is switched from the voltage VSH to the voltage VSL, so that the voltage Vipx becomes lower by the voltage ΔVpix.

In addition, in this embodiment, a timing at which, after the selection of one of the scanning lines 112 has been completed, it is determined whether the capacitor line Sc(i, i+1) supplied to the capacitor line 132 is to be switched from the voltage VSL to the voltage VSH, or is to be switched from the voltage VSH to the voltage VSL, is caused to correspond to a timing at which a subsequent one of the scanning lines 112 has been selected. For this reason, the above-described scanning line 112 for the 321st line is used as a dummy scanning line for causing the capacitor line driving circuit 150 connected to the scanning line 112 for 319th and 320th lines to operate. A configuration for determining a timing for performing such a switching is not limited to the above-described configuration, but any configurations, in each of which, after the selection of a relevant one of the scanning lines 112 has been completed, the switching is performed, can be adopted.

By using such a configuration as described above, since a voltage range of the pixel electrode 118 is enlarged so that it becomes larger than a voltage amplitude of a data signal, conversely, the voltage amplitude of a data signal can be smaller than the voltage range of the pixel electrode 118, withstand voltages of respective elements constituting the data line driving circuit 140 need not be enlarged, and further, since the voltage amplitude of each of data signals supplied to the data lines 114 can be reduced, power consumption for the data line driving circuit 140 can be suppressed.

By the way, it takes a certain amount of time (a relax time) from a timing when a selection of the scanning lines 112 is started until a timing when the capacitor line 132 has been relaxed to the voltage VSH or the voltage VSL. Further, increase of on-resistances of the switches 152 and 153, wiring resistances of the capacitor lines, and loads due to various parasitic capacitances with respect to the capacitor lines makes the relax time longer. Therefore, if a period of time while the scanning line 112 is selected is shorter than the relax time, the selection of the scanning line 112 is likely to be terminated before the capacitor line 132 has been relaxed to the voltage VSH or the voltage VSL.

FIG. 8 is a timing chart illustrating a state of time-series changes of respective voltages with respect to the pixel 110. The continuous line denotes a voltage of the scanning line 112, the dotted line denotes a voltage of the capacitor line, and the chain line denotes the voltage Vpix of the pixel electrode 118. FIG. 8A is a diagram illustrating a state of time-series changes of respective voltages in the case where the scanning lines 112 are exclusively selected on a line-by-line basis. FIG. 8B is a diagram illustrating a state of time-series changes of respective voltages in the case where, just like in this embodiment, n lines of the scanning lines form a group (n=2, in this embodiment), and on a group-by-group basis, the scanning lines 112 are selected. Further, it is assumed that respective frame periods in FIGS. 8A and 8B are the same. It is also assumed that, in each of FIGS. 8A and 8B, time passes in a direction indicated by an arrow.

In addition, hereinafter, operations performed in the case where a writing polarity is a positive polarity will be described, but in the case where a writing polarity is a negative polarity as well, phenomena of qualities the same as or similar to those in the case where a writing polarity is a positive polarity occur. Therefore, in the following description with reference to FIG. 8, the voltage “VSH” and the voltage “VSL” may be appropriately replaced by the voltage “VSL” and the voltage “VSH”, respectively.

Firstly, as shown in FIG. 8A, in the configuration in which the scanning lines 112 are selected on a line-by-line basis, the length of a selection period for each of the scanning lines 112 relative to a predetermined frame period is denoted by “T”. A voltage of the pixel electrode 118 varies in accordance with an operation of writing into the pixel electrode 118, and a voltage of a capacitor line varies in accordance with capacitive coupling via the auxiliary capacitor 125. Further, sometimes, the selection period is terminated before a voltage of the capacitor line 132 has been relaxed to the voltage VSL again. Moreover, when the selection period has been terminated, and the TFT transistor has been turned on, load is reduced, so that, immediately, the voltage of the capacitor line 132 moves to the voltage VSL. Such a condition is shown in an area indicated by “I” of FIG. 8A. Further, subsequent to termination of the selection period, the voltage of the capacitor line is caused to shift from the voltage VSL to the voltage VSH. Owing to such a phenomenon, although the voltage of the Vpix rises, since, owing to the behavior shown in the area denoted by “I”, the voltage Vpix is unlikely to reach a desired voltage. This phenomenon is different from a phenomenon with respect to a field-through voltage due to a parasitic capacitance between a electrode for a corresponding scanning line and an electrode for a corresponding pixel electrode, and occurs fundamentally owing to a lack of response from a corresponding capacitor line. As described above, the phenomenon, in which the voltage of the pixel electrode 118 is unlikely to reach a desired voltage, sometimes, causes disadvantages in display of images, and is not preferable in the capacitor line driving. In particular, the phenomenon is a significant problem in realization of a high-speed driving, such as a subfield driving.

In contrast therewith, in the electro-optical apparatus 1 according to this embodiment, n (n=2) lines of the scanning lines form a group, and on a group-by-group basis, the scanning lines 112 are selected. Compared with a configuration in which the scanning lines 112 are selected on a line-by-line basis, such a configuration enables the selection period during which one of the scanning lines 112 is selected to be increased to 2T (double the selection period shown in FIG. 8A), along with maintaining the length of the frame period in the configuration in which the scanning lines 112 are selected on a line-by-line basis. As shown in FIG. 8B, such a configuration, in which a plurality of the scanning lines 112 are simultaneously selected, enables not changing the length of the frame period, and further, ensuring a sufficient length of the selection period. Therefore, during the selection period, the voltage of the capacitor line 132 can be sufficiently relaxed to the voltage VSL or the voltage VSH, and after the selection period, the capacitor line driving circuit 150 can shift the voltage of the capacitor line 132 to the voltage VSH or the voltage VSL. When realizing the capacitor line driving, such a method enables suppression of the voltage of the pixel electrode 118 from becoming an unintended voltage, and stabilization of the voltage of the pixel electrode 118 after writing of data into the pixel electrode 118 has been completed.

According to the first embodiment having been described so far, the electro-optical apparatus 1 including the capacitor lines 132 enables a voltage of the capacitor line 132 to be a predetermined voltage (i.e., VSL or VSH) when writing of data into the pixel electrode 118 has been completed.

Further, the configuration of this embodiment makes it unnecessary to provide the switches 152 and 153 included in the capacitor line driving circuit 150 with high capabilities, and thus, is preferable in reduction of circuit areas for the switches.

Furthermore, the simultaneous selection of a plurality of the scanning lines 112, provided in the scanning line driving circuit 130, enables lowering of the clock frequency Cly associated with the vertical scanning, further, reducing the number of lines of the scanning lines 112 selected by the scanning line driving circuit 130 to 1/n (1/2, in this embodiment), and thus, contributes to downsizing of the shift registers.

### Second Embodiment

Next, a second embodiment according to the invention will be hereinafter described.

An electro-optical apparatus according to this second embodiment is different from the electro-optical apparatus according to the first embodiment in combinations of the scanning lines 112 that are simultaneously selected. In the following description, among elements included in an electro-optical apparatus la according to this embodiment, elements common to the elements included in the electro-optical apparatus 1 according to the first embodiment are provided with the same reference symbols, and descriptions and illustrations of such elements will be appropriately omitted.

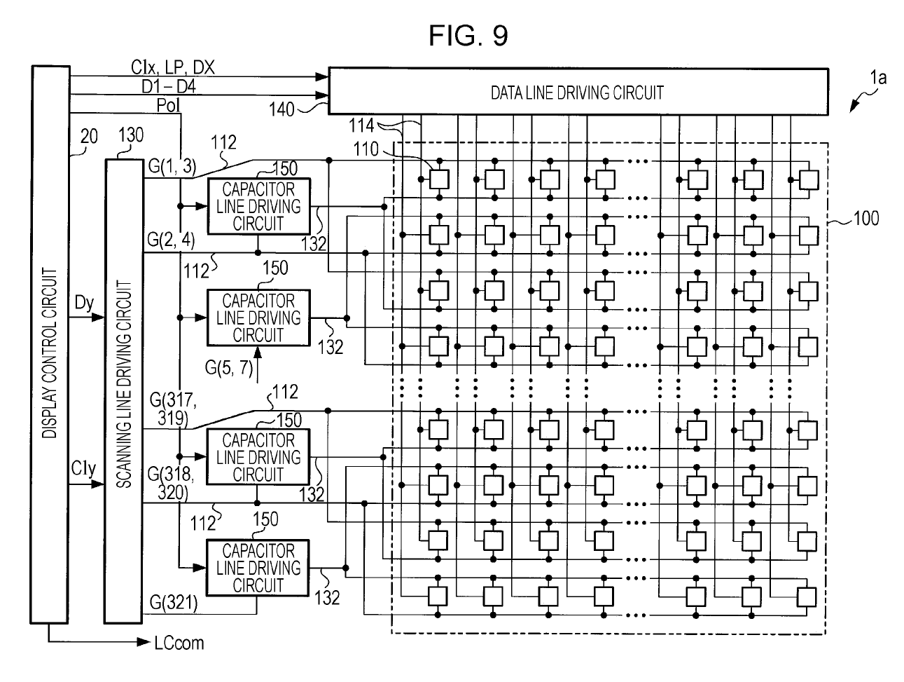

FIG. 9 is a block diagram illustrating a configuration of the whole electro-optical apparatus 1a according to the second embodiment.

As shown in FIG. 9, in this embodiment, the scanning line driving circuit 130 simultaneously selects two lines of the scanning lines 112 from among odd numbered lines thereof or even numbered lines thereof. Specifically, the scanning line driving circuit 130 forms a group consisting of an i-th line and an (i+2)th line of the scanning lines. Further, the scanning line driving circuit 130 supplies the i-th line and the (i+2)th line of the scanning lines with a scan signal G(i, i+2), which is common thereto. Further, for each group of the scanning lines 112, between one line and the other line of the scanning lines 112 included in a group, the other line thereof being adjacent to the one line thereof, one line of the scanning lines 112 included in each of different groups, to which the scan signal G(i+1, i+3) is supplied, is interposed.

A configuration according to this embodiment brings effects the same as or similar to those of the first embodiment.

Further, the electro-optical apparatus la according to this embodiment provides the following behavior.

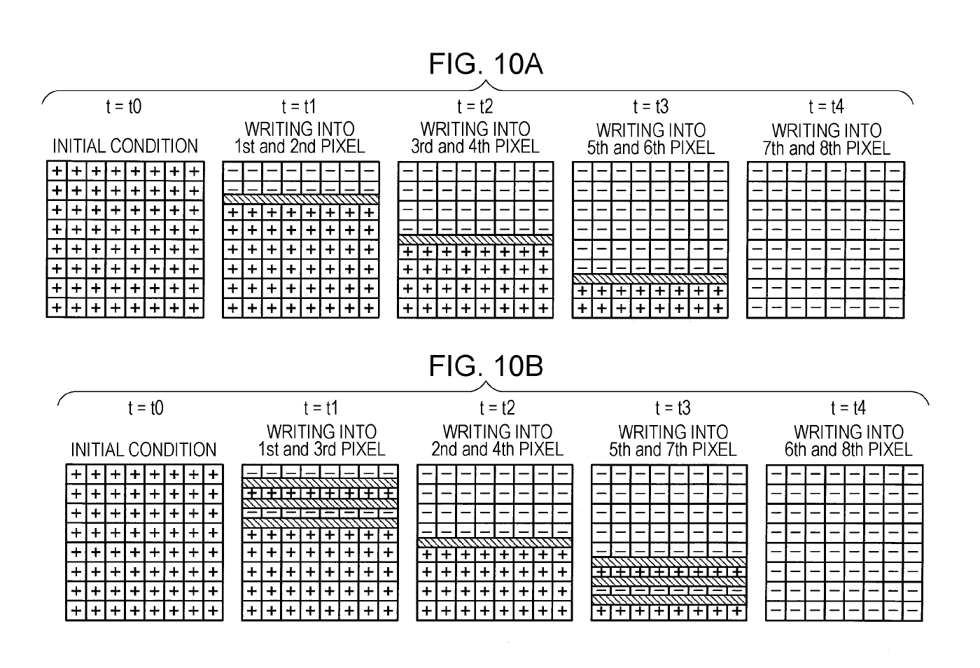

FIG. 10 is a diagram illustrating polarities of the pixel electrodes 118 corresponding to the respective pixels 110 included in the display area 100.

In FIG. 10, each of rectangles corresponds to one of the pixel 110, and here, for the sake of convenience in explanation, explanation will be made by using a display area consisting of 8×8 pixels. Further, each rectangle appended by “+” indicates that the polarity of the pixel electrode 118 corresponding to the pixel 100 is a positive polarity, and each rectangle appended by “−” indicates that the polarity of the pixel electrode 118 corresponding to the pixel 100 is a negative polarity. Further, FIG. 10A shows conditions of polarity changes in the case where, just like the method in the first embodiment, the scanning lines 112 are simultaneously selected, and FIG. 10B shows conditions of polarity changes in a configuration according to this second embodiment. Further, it is assumed that, as an initial condition, all the polarities of the pixel electrodes 118 are “+”, and from now, writing of data is performed with a negative writing polarity.

A condition appended by “t=t1” shows a condition in which writing of data into the pixels 100 corresponding to a 1st group of the scanning lines 112 has been completed. As shown in FIG. 10A, in the configuration according to the first embodiment, at a timing when writing of data into the 1st and 2nd lines of the pixels has been completed, the polarities of the pixel electrodes 118 corresponding to these lines of pixels are negative polarities. Therefore, since a polarity of the 2nd line of pixels and a polarity of a 3rd line of pixels are inverse to each other, in an area where these lines of pixels are located adjacent to each other, the condition appended by “t=t1” shows a condition in which an electric field in a lateral direction (hereinafter, which will be called “a lateral electric field”) due to voltage differences occurring between the pixel electrodes 118 is likely to occur. Such a lateral electric field causes defects of alignment directions of liquid crystal molecules, that is, so-called disclination, and thereby, sometimes, a quality level of display in the display area 100 is degraded. Thus, it is preferable to suppress occurrence of the lateral electric field as much as possible.

Meanwhile, as shown in FIG. 10B, in the configuration according to this second embodiment, at a timing when writing of data into the 1st and 3rd lines of the pixels has been completed, the polarities of the pixel electrodes 118 corresponding to these lines of pixels are negative polarities. Therefore, since there are three polarity inverse relations between respective polarities of two lines of the pixel electrodes 118, a first one being a polarity inverse relation between respective polarities of 1st line and 2nd lines, a second one being a polarity inverse relation between respective polarities of 2nd and 3rd lines, a third one being a polarity inverse relation between respective polarities of 3rd and 4th lines, here, there occur three areas each extending in a line direction, in which lateral electric fields are strengthened.

A condition appended by “t=t2” shows a condition in which writing of data into the pixels 100 corresponding to a 2nd group of the scanning lines 112 has been completed.

As shown in FIG. 10A, in the configuration of the first embodiment, after writing of data into 3rd and 4th lines of pixels has been completed, since polarities of 4th and 5th lines are inverse to each other, in this case as well, in an area extending in a line direction, lateral electric fields occur. Meanwhile, as shown in FIG. 10B, in the configuration according to this second embodiment, after writing of data into 2nd and 4th lines of pixels has been completed, since polarities of 4th and 5th lines are inverse to each other, in this case as well, in an area extending in a line direction, lateral electric fields are strengthened. Here, occurrence conditions of lateral electric fields in the respective configurations according to the first embodiment and the second embodiment are the same.

A condition appended by “t=t3” shows a condition in which writing of data into the pixels 100 corresponding to a 3rd group of the scanning lines 112 has been completed. As shown in FIG. 10A, in the configuration according to the first embodiment, after writing of data into 5th and 6th lines of pixels has been completed, since polarities of 5th and 6th lines are inverse to each other, in this case as well, in an area extending in a line direction, lateral electric fields occur. Meanwhile, as shown in FIG. 10B, in the configuration according to this second embodiment, after writing of data into 5th and 7th lines of pixels has been completed, since there occur three polarity inverse relations, a fist one occurring between polarities of 5th line and 6th lines, a second one occurring between polarities of 6th and 7th lines, a third one occurring between polarities of 7th and 8th lines, in this case as well, in three areas each extending in a line direction, lateral electric fields are strengthened.

A condition appended by “t=t4” shows a condition in which, after writing of data into the pixels 100 corresponding to a 4th group of the scanning lines 112 has been completed, polarities of the pixel electrodes 118 corresponding to all the pixels are negative polarities.

Focusing on such time-series changes of polarities of the pixel electrodes 118, as shown in FIG. 10A, in the configuration according to the first embodiment, between the 2nd line and the 3rd line, the 4th line and the 5th line, or the 6th line and 7th line, an area, in which lateral electric fields are strengthened, occurs, and in subsequent writing operations, lateral electric fields are likely to occur at the same positions. That is, portions, at which any lateral electric fields occur, and portions, at which any electric fields does not occur, are fixed. In contrast, in the configuration according to the second embodiment, there are opportunities in which, in areas between any two successive lines of pixels, it is possible to evenly strengthen electric fields. In this manner, it is possible to uniformize areas, in which lateral electric fields occur, all over the display area 100. Therefore, compared with the configuration according to the first embodiment, it can be expected to, without any particular devices, cause any defects of display due to disclination to be unnoticeable. On the contrary, for the configuration according to the first embodiment, there is an advantage in that the number of areas, in which lateral electric fields occur, is small.

### Third Embodiment

Next, a third embodiment according to the invention will be hereinafter described. In the following description, among elements included in an electro-optical apparatus 1b according to this embodiment, elements common to the elements included in the electro-optical apparatus 1 according to the first embodiment are provided with the same reference symbols, and descriptions and illustrations of the elements will be appropriately omitted.

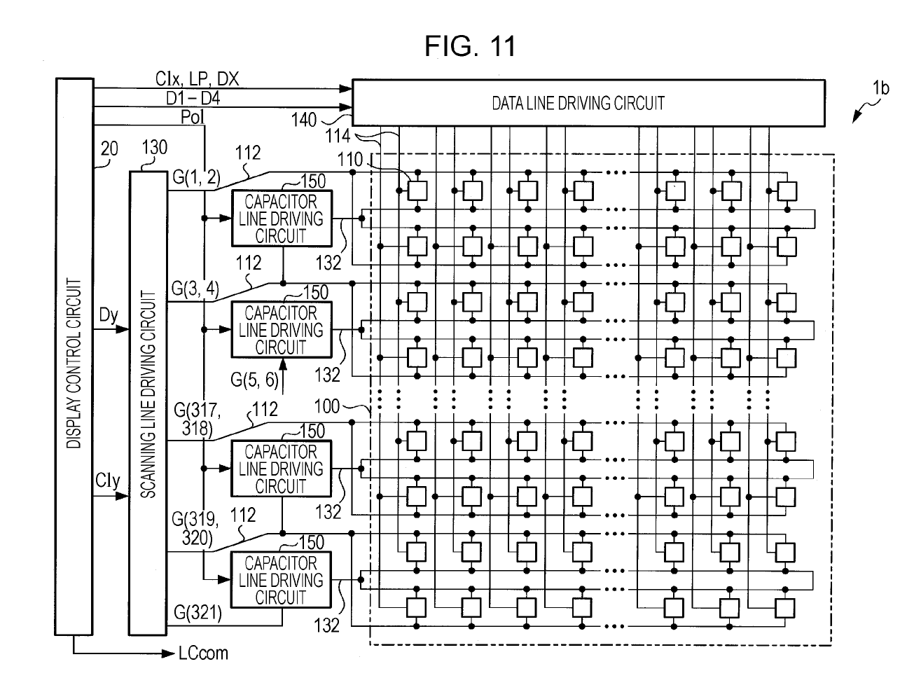

FIG. 11 is a block diagram illustrating the whole configuration of an electro-optical apparatus according to a third embodiment.

This electro-optical apparatus according to the third embodiment is different from the electro-optical apparatus 1 according to the first embodiment in only a configuration of the capacitor lines 132. Specifically, the two capacitor lines 132 corresponding to the respective two scanning lines 112 forming a group have respective one side edges thereof, which are electrically connected to the capacitor line driving circuit 150, and the respective other side edges thereof, which are electrically connected to each other.

Such a configuration enables suppression of occurrence of voltage differences between any two of the plurality of capacitor lines 132 driven by one of the capacitor line driving circuit 150, thus, enables matching of drives performed by the respective capacitor lines 132, and as a result, enables suppression of occurrences of so-called lateral crosstalk. If possible, the capacitor lines 132 belonging to the same group may be configured to be connected to one another, not only at edge portions of the respective capacitor lines, but also at portions corresponding to respective adjacent pixels, each being successively located, or located at every several pixels.

In addition thereto, the configuration according to the third embodiment brings behavior effects the same as or similar to those in the above-described first embodiment.

### Fourth Embodiment

Next, a fourth embodiment according to the invention will be hereinafter described.

In the following description, among elements included in an electro-optical apparatus la according to this embodiment, elements common to the elements included in the electro-optical apparatus 1 according to the first embodiment are provided with the same reference symbols, and descriptions and illustrations of the elements will be appropriately omitted.

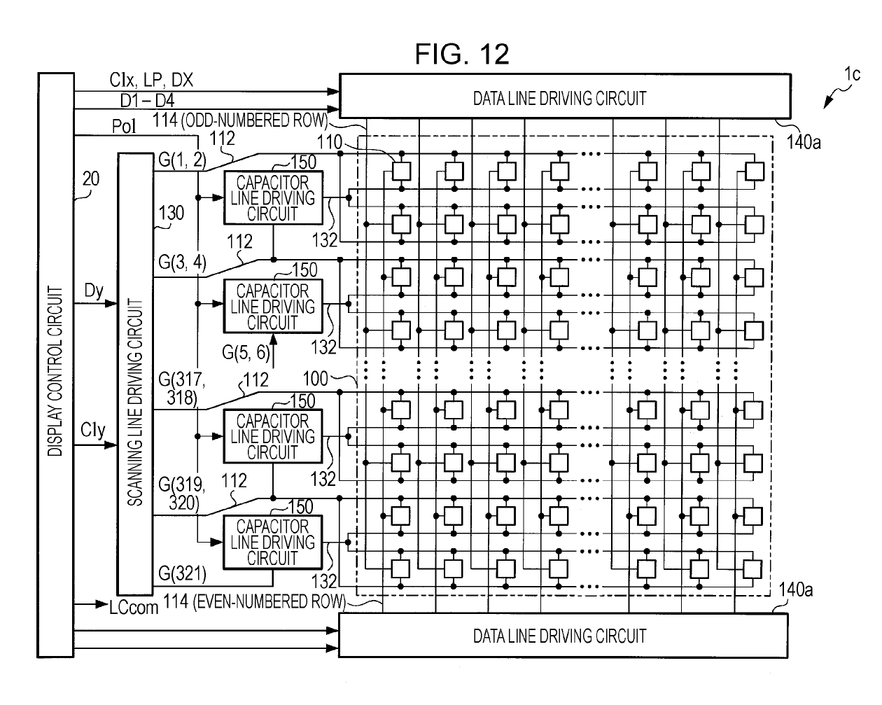

FIG. 12 is a block diagram illustrating the whole configuration of an electro-optical apparatus 1c according to a fourth embodiment.

As shown in FIG. 12, in this embodiment, two data line driving circuits are each lengthened in a direction along which data lines are arrayed, and these data line driving circuits are provided at positions, interposing the display area 100 therebetween, and being opposite each other. Two data line driving circuits 140a have the same configuration. When two lines of the scanning lines 112 are selected, the data line driving circuits 140a, which correspond to the respective two lines thereof, and are different from each other, sequentially provide data signals to the individual pixels 100 that are provided so as to correspond to the respective two lines thereof.

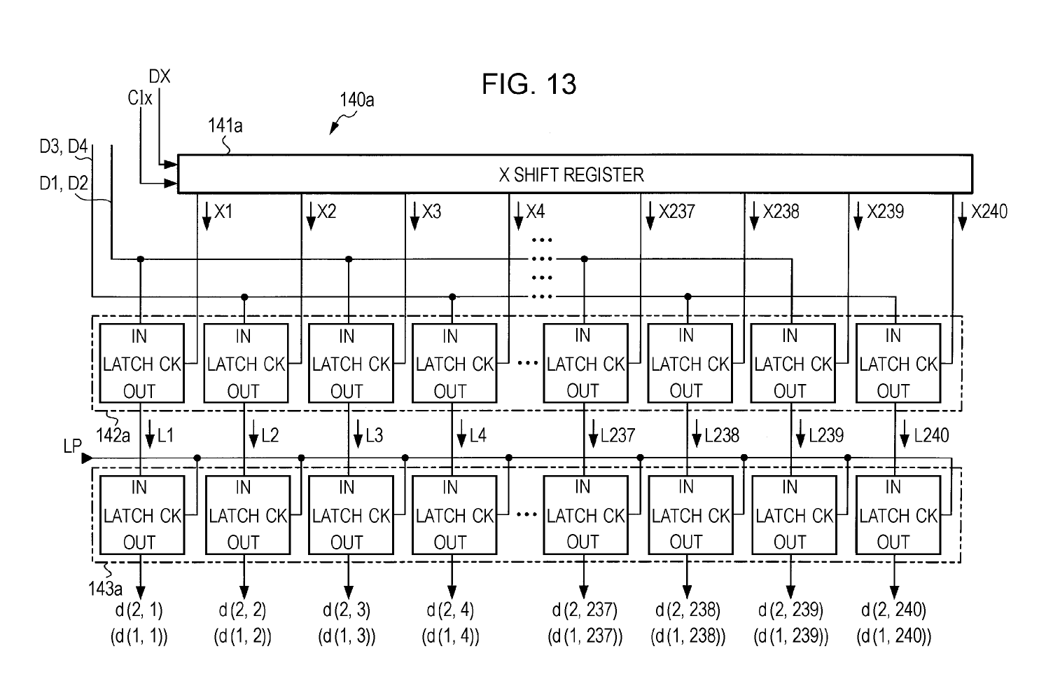

FIG. 13 is a diagram illustrating a configuration of the data line driving circuit 140a according to this embodiment. FIG. 13 shows a configuration of the data line driving circuit 140a, which supplies data signals to even numbered lines of the data lines 114 on the basis of the data bits D1 and D3.

In addition, here, a case, in which 1st and 2nd lines of the scanning lines 112 are selected by the scanning line driving circuit 130, will be described. Further, the data line driving circuit 140a, which supplies data signals to odd numbered lines of the data lines 114 on the basis of the data bits D2 and D4, has a configuration the same as or similar to that shown in FIG. 13.

The data line driving circuit 140a includes an X shift register 141a, a first group of latch circuits 142a and a second group of latch circuits 143a.

The X shift register 141a sequentially shifts the transfer start pulse DX, which is supplied at the beginning of each horizontal scanning period, at respective timings of rising and falling edges of the clock signal Clx, and exclusively supplies the outputs of itself as latch signals as X1, X2, X3, . . . , X240. The first group of latch circuits 142a sequentially latches the data bits D1 and D3 at timings of respective rising edges of the latch signals X1, X2, X3, . . . , X240, and outputs the latched signals as latch signals L1, L2, L3, . . . , L240. The second group of latch circuits 143a simultaneously latches the individual latch signals resulting from latching performed by the first group of latch circuits 142a at respective timings of rising edges of the latch pulse LP, and then, supplies the latched signals to the corresponding data lines 114 as data signals. Specifically, the second group of latches 143a, which supplies even numbered lines of the data lines 114 with data signals, outputs data signals d(2, 1), d(2, 2), d(2, 3), d(2, 4), . . . , d(2, 237), d(2, 238), d(2, 239) and d(2, 240) to the data lines 114. The second group of latches 143a, which supplies odd numbered lines of the data lines 114 with data signals, outputs data signals d(1, 1), d(1, 2), d(1, 3), d(1, 4), . . . , d(1, 237), d(1, 238), d(1, 239) and d(1, 240) to the data lines 114.

As described above, the electro-optical apparatus 1c is configured to, to the pixels 110, which are provided so as to correspond to n lines of the scanning lines 112 forming a group, cause data line driving circuits, which are different for each of the scanning lines (lines), to supply data signals. Such a configuration does not need any particular devices for the structure of the pixels 110, and enables writing of data into selected n lines of the pixels 110 by using generally-configured data line driving circuits. In addition thereto, the configuration according to the fourth embodiment brings behavior effects the same as or similar to those in the above-described first embodiment.

### Modified Example

The invention can be practices in embodiments different from the above-described embodiments. For example, the present invention can be also practiced in the following embodiments. Further, each of the following modified examples may be appropriately combined.

### Modified Example 1

The above-described configurations according to the respective embodiments may be appropriately combined.

For example, the above-described configuration according to the third embodiment, that is, the configuration, in which two capacitor lines 132, which correspond to the respective two scanning lines 112 forming a group have respective one side edges thereof, which are electrically connected to the capacitor line driving circuit 150, and the respective other edges thereof, which are electrically connected to each other, may be applied to the above-described configurations according to the respective second and fourth embodiments. Further, the configuration for supplying data signals in the fourth embodiment may be applied to a configuration, just like the configuration according to the second embodiment, in which, for an electro-optical apparatus, between any two adjacent lines of certain lines of the scanning lines 112, the certain lines forming a group, one scanning line of a different group is interposed.

### Modified Example 2

In the above-described embodiments, n is set to “2”, and the scanning line driving circuit 130 simultaneously selects two lines of the scanning lines 12, as well as simultaneously drives two lines of the capacitor lines 132, corresponding to the two scanning lines 112 having been simultaneously selected. In this regard, if n is set to numbers more than or equal to “3”, it is possible to apply the present invention to any configurations employing such numbers. That is, even if a configuration, in which the scanning line driving circuit 130 simultaneously selects any n lines of the scanning lines 112, and further, simultaneously drives n lines of the capacitor lines 132, corresponding to the n scanning lines 112 having been simultaneously selected, is adopted, the adopted configuration brings effects the same as or similar to those in the above-described embodiments. If a frame period is fixed to a certain period of time, increasing of the value of n makes it possible to enlarge a selection period of each of the scanning lines 112. Therefore, even if a data writing period becomes shorter, or the like, it is possible to, during each selection period, relax the capacitor line 132 to a predetermined voltage.

In addition, in the configuration according to the fourth embodiment, the data line driving circuits 140a, the number of which is equal to n, are provided. Further, in the above-described configuration according to the second embodiment, the number of scanning lines, which are interposed between one line of the scanning lines 112, and the other adjacent line of the scanning lines, the one line thereof and the other adjacent line thereof being included a group, may be more than “2”. Further, in this case, any scanning lines belonging to other groups, the number of which is more than “2”, may be interposed therebetween.

### Modified Example 3

In the above-described embodiments, the capacitor line driving circuit 150 may not be realized by using the TFTs the same as or similar to those functioning as pixel switching elements included in the display area 100, but may be configured by separated IC chips, which are implemented at both sides, i.e., a left-hand side and a right-hand side, of the display area 100, respectively. Further, respective configurations of the embodiments may employ a transparent type, not a reflective type, and may be a semi-transparent/semi-reflective type, which combines the transparent type and the reflective type.

Further, the pixel capacitance 120 is not limited to a normally-black mode, but may be a normally-white mode.

Further, color displaying may be performed by using dots each being formed of three color pixels, i.e., R(red), G(green) and B(blue) pixels. Further, other color pixels are added thereto, and each dot may be formed of more than four color pixels.

Further, the invention is not limited to applications to the electro-optical apparatuses each representing gray scales by using subfield driving, but may be applied to, for example, electro-optical apparatuses each employing a voltage modulation method for supplying voltages corresponding to respective gray-scale levels.

Further, the numbers of the scanning lines and the data lines 114 included in the display area 100 are just examples.

### Modified Example 4

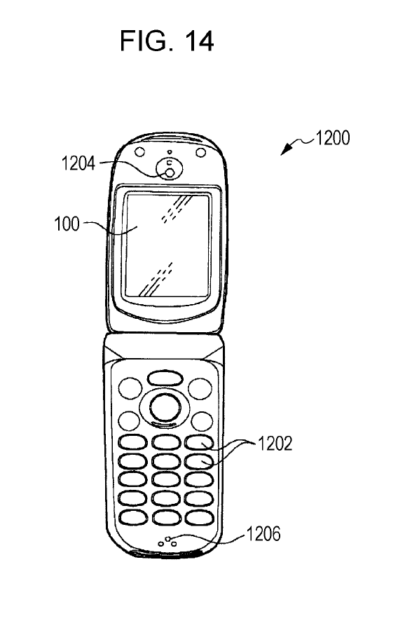

Next, electronics devices each including any one of the above-described electro-optical apparatuses according to the respective embodiments. FIG. 14 is a diagram illustrating a configuration of a mobile-phone 1200 using any one of the electro-optical apparatuses according to the respective embodiments.

As shown in FIG. 14, the mobile-phone 1200 is configured to, in addition to a plurality of operation buttons 1202, include a ear piece 1204 and a mouthpiece 1206, as well as any one of the above-described electro-optical apparatuses. In addition, components included in a portion corresponding to the display area 100 within the electro-optical apparatus do not appear as an external view.

In addition, as an electronics device to which the invention can be applied, beside a mobile-phone shown in FIG. 14, a digital steel camera, a notebook-size personal computer, a liquid crystal display TV, a viewfinder type (or a monitor-direct-view type) video recorder, a car navigation apparatus, a pager, an electronic organizer, an electric calculator, a word processor, a work station, a video phone, a point-of-sale terminal, a device including a touch panel, and the like can be provided. Further, needless to say, as a display apparatus for each of these electronics devices, the above-described electro-optical apparatus can be applied. Further, the invention may be applied to projection-type display apparatuses (projectors) each using the display area 100 as a light valve.

The entire disclosure of Japanese Patent Application No. 2010-103107, filed Apr. 28, 2010 is expressly incorporated by reference herein.

What is claimed is:

1. An electro-optical apparatus comprising:
scanning lines;
data lines;
capacitor lines corresponding to the respective scanning lines;
a pixel corresponding to an intersection of one of the scanning lines and a group of the data lines, the group of the data lines including n (n is an integer greater than or equal to 2) lines of the data lines, the pixel including:
a switching element having a node that is electrically connected to the one of the group of data lines, the switching element being in a conductive condition between the node and another node when the one of the scanning lines is selected; and
a storage capacitor having a node that is electrically connected to the another node of the switching element, and another node that is electrically connected to the capacitor line;
a scanning line driving circuit for selecting a group of the scanning lines, the group of the scanning lines including n lines of the scanning lines;
a data line driving circuit for supplying pixels corresponding to selected group of the scanning lines with data signals having voltages in accordance with gray scales for the pixels via the group of the data lines; and
a capacitor line driving circuit for supplying a first potential signal to a group of the capacitor lines corresponding to respective selected group of the scanning lines when the group of the scanning lines have been selected, subsequently varying the first potential signal to a second potential signal.

2. The electro-optical apparatus according to claim 1, wherein the scanning line driving circuit selects the scanning lines so that, for n lines of the scanning lines forming the group, between one of the group of the scanning lines and a different line of the group of the scanning lines, a predetermined number of the scanning lines included in a different group of the scanning lines can be interposed.

3. The electro-optical apparatus according to claim 1, wherein n mutually adjacent lines of the scanning lines form a group.

4. The electro-optical apparatus according to claim 1, wherein n lines of the group of the capacitor lines corresponding to the group of the scanning lines have respective one side edges thereof, which are electrically connected to the capacitor line driving circuit, and the respective other side edges thereof, which are electrically connected to one another.

5. The electro-optical apparatus according to claim 1, wherein the data line driving circuit includes n data line driving circuits, and
wherein each of the data line driving circuits sequentially supplies data signals to respective pixels corresponding to one of the scanning lines, and wherein each of the data line driving circuits supply data signals to pixels corresponding to each scanning line of the group of the scanning lines.

6. An electronics device comprising the electro-optical apparatus according to claim 1.
